(19) United States
(12) Patent Application Publication
(10) Pub. No.: US 2023/0009871 A1
(43) Pub. Date: Jan. 12, 2023

(54) ELECTROLYTE MADE FROM LITHIUM SALT

(71) Applicant: ARKEMA FRANCE, Colombes (FR)

(72) Inventors: Gregory SCHMIDT, Pierre-Benite Cedex (FR); Dmitri COLESNIC, Verneuil en Halatte (FR)

(73) Assignee: ARKEMA FRANCE, Colombes (FR)

(21) Appl. No.: 17/776,947

(22) PCT Filed: Nov. 5, 2020
(86) PCT No.: PCT/FR2020/052006

§ 371 Date: May 13, 2022

(30) Foreign Application Priority Data
Nov. 22, 2019 (FR) 1913118

(51) Int. Cl. H01M 10/0568; H01M 10/0525; H01M 10/0569; H01M 10/36; H01M 10/0567

(52) U.S. Cl. CPC H01M 10/0568; H01M 10/0525; H01M 10/0569; H01M 10/36; H01M 10/0567; H01M 2300/0028

(57) ABSTRACT

An electrolyte composition including:
i) at least one lithium salt;
ii) at least one nonaqueous solvent; and
iii) at least one product from reaction of a mixture including:
   a) at least one diamine selected from:
      a1) a linear aliphatic C2 to C24 diamine; and/or
      a2) a cycloaliphatic C6 to C18 diamine; and/or
      a3) an aromatic, preferably C6 to C24, diamine;
   b) at least one saturated hydroxylated C3-C36 carboxylic acid;
   c) at least one monoacid selected from saturated linear and non-hydroxylated C2 to C18 carboxylic acids;

the composition having a viscosity measured at 23° C. ranging from 101 to 107 mPa·s.

### FIELD OF THE INVENTION

The present invention relates to an electrolyte composition comprising at least one lithium salt.

The present invention also relates to the use of such an electrolyte composition for reducing/delaying the formation of dendrites.

### TECHNICAL BACKGROUND

One of the major challenges in the field of batteries is that of increasing the energy density with a view in particular to improving the autonomy of electric vehicles. One of the solutions envisioned is a change of anode materials. Currently, the anode material is generally graphite which has a capacity of 350 mAh/g. Switching to a lithium metal anode which has a capacity of 3860 mAh/g would make it possible to greatly increase the energy density of Li-ion batteries. There are several Li-ion batteries comprising a lithium metal anode: “conventional” lithium-ion batteries or Li-sulfur batteries.

However, Li-ion batteries comprising a lithium metal anode are not sold at this stage because of battery life problems mainly linked to the formation of dendrites. A dendrite is a lithium filament that is created when the battery is charged. This filament can then grow until it passes through the separator and generates a short circuit resulting in the irreversible degradation of the Li-ion battery.

New technologies, such as solid electrolytes, have been developed in order to combat the formation of these dendrites. However, this technology does not make it possible to achieve the performance levels of Li-ion batteries obtained with liquid electrolytes, in particular because of their low ionic conductivity.

As regards liquid electrolytes, they have some intrinsic limitations such as safety issues due to possible leakage of these liquids containing flammable and volatile solvents.

There is therefore a need for new electrolytes which at least partially remedy one of the abovementioned drawbacks.

More particularly, there is a need for novel electrolyte compositions which make it possible to reduce or even eliminate the formation of dendrites on the surface of electrodes.

### DESCRIPTION OF THE INVENTION

The present application relates to an electrolyte composition comprising:
i) at least one lithium salt;
ii) at least one nonaqueous solvent; and
iii) at least one product from reaction of a mixture comprising:
   a) at least one diamine selected from:
      a1) a linear aliphatic C₂ to C₂₄ diamine; and/or
      a2) a cycloaliphatic C₆ to C₁₈ diamine; and/or
      a3) an aromatic, preferably C₆ to C₂₄, diamine;
   b) at least one saturated hydroxylated C₃-C₃₆ carboxylic acid;
   c) at least one monoacid selected from saturated linear and non-hydroxylated C₂ to C₁₈ carboxylic acids;
      said composition being characterized in that it has a viscosity measured at 23° C. ranging from 10¹ to 10⁷ mPa·s.

In the context of the invention, and unless otherwise mentioned, the terms “electrolyte composition” and “electrolyte” are used interchangeably.

The measurement of viscosity at 23° C. can be done in accordance with standard NF EN ISO 2555 using a Brookfield® viscometer. Typically, the measurement carried out at 23° C. can be performed using a Brookfield® viscometer with a spindle suited to the viscosity range and at a rotational speed of 10 revolutions per minute (rpm).

Preferably, the composition has a viscosity measured at 23° C. ranging from 10² to 10⁶ mPa·s.

### Composition

Preferably, the electrolyte composition is an electrolyte composition for batteries, and in particular for Li-ion batteries.

Lithium Salt i)

The lithium salt may be chosen from the group consisting of LiPF₆ (lithium hexafluorophosphate), LiFSI, LiTDI, LiTFSI (lithium bis(trifluorosulfonyl)imide), LiPOF₂, LiB(C₂O₄)₂, LiF₂B(C₂O₄)₂, LiBF₄, LiNO₃, LiClO₄, and mixtures thereof.

The lithium salt is preferably LiFSI.

In the context of the invention, the terms “lithium salt of bis(fluorosulfonyl)imide”, “lithium bis(fluorosulfonyl)imide”, “LiFSI”, “LiN(FSO₂)₂ or “lithium bis(fluorosulfonyl)imide” are used equivalently.

Lithium 2-trifluoromethyl-4,5-dicyanoimidazolate, known under the name LiTDI, has the following structure:

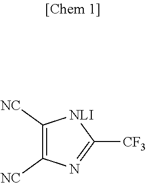

Preferably, the lithium salts represent between 2% and 100% by weight of all the salts present in the electrolyte composition, preferably between 25% and 100% by weight, and preferentially between 50% and 100% by weight.

The total molar concentration of lithium salt(s) in the electrolyte composition can range from 0.01 mol/l to 5 mol/l, preferably from 0.05 mol/l to 3 mol/l.

Nonaqueous Solvent ii)

The electrolyte composition may comprise a nonaqueous solvent or a mixture of different nonaqueous solvents, such as for example two, three or four different solvents.

The nonaqueous solvent of the electrolyte composition can be a liquid solvent, optionally gelled by a polymer, or a polar polymer solvent optionally plasticized by a liquid.

According to one embodiment, the nonaqueous solvent is an aprotic organic solvent. Preferably, the solvent is a polar aprotic organic solvent.

According to one embodiment, the nonaqueous solvent is chosen from the group consisting of ethers, esters, carbonates, ketones, partially hydrogenated hydrocarbons, nitriles, amides, sulfoxides, sulfolane, nitromethane, 1,3-dimethyl-2-imidazolidinone, 1,3-dimethyl-3,4,5,6-tetrahydro-2(1H)-pyrimidinone, 3-methyl-2-oxazolidinone and mixtures thereof.

Among the ethers, mention may be made of linear or cyclic ethers, such as, for example, dimethoxyethane (DME), methyl ethers of oligoethylene glycols of 2 to 5 oxyethylene units, 1,3-dioxolane (CAS No. 646-06-0), dioxane, dibutyl ether, tetrahydrofuran, and mixtures thereof.

Among the esters, mention may be made of phosphoric acid esters or sulfite esters, methyl formate, methyl acetate, methyl propionate, ethyl acetate, butyl acetate, γ-butyrolactone and mixtures thereof.

Mention may in particular be made, among the ketones, of cyclohexanone.

Mention may be made, among the nitriles, for example, of acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile and mixtures thereof.

Mention may be made, among the carbonates, for example, of cyclic carbonates, such as, for example, ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS: 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435-02-8), trifluoropropylene carbonate (CAS: 167951-80-6) or mixtures thereof.

Preferably, the nonaqueous solvent is chosen from the group consisting of carbonates, ethers and mixtures thereof.

Mention may in particular be made of the following mixtures:
Dimethoxyethane (DME),
Dimethoxyethane/1,3-dioxolane 1/1 by weight,
Dimethoxyethane/1,3-dioxolane 2/1 by weight,
Dimethoxyethane/1,3-dioxolane 3/1 by weight,
Dimethoxyethane/1,3-dioxolane 1/1 by volume,
Dimethoxyethane/1,3-dioxolane 2/1 by volume,
Dimethoxyethane/1,3-dioxolane 3/1 by volume,
Ethylene carbonate/propylene carbonate/Dimethyl carbonate 1/1/1 by weight,
Ethylene carbonate/propylene carbonate/Diethyl carbonate 1/1/1 by weight,
Ethylene carbonate/propylene carbonate/Ethyl methyl carbonate 1/1/1 by weight,
Ethylene carbonate/Dimethyl carbonate 1/1 by weight,
Ethylene carbonate/Diethyl carbonate 1/1 by weight,
Ethylene carbonate/Ethyl methyl carbonate 1/1 by weight,
Ethylene carbonate/Dimethyl carbonate 3/7 by volume,
Ethylene carbonate/Diethyl carbonate 3/7 by volume,
Ethylene carbonate/Ethyl methyl carbonate 3/7 by volume.

Preferably, the abovementioned electrolyte composition comprises dimethoxyethane.

The total weight content of the nonaqueous solvent(s) in the electrolyte composition may be greater than or equal to 40% by weight, preferably greater than or equal to 50% by weight, and advantageously greater than or equal to 60% by weight, relative to the total weight of the composition.

Reaction Product iii)

The abovementioned electrolyte composition comprises iii) at least one product from reaction of a mixture comprising:
a) at least one diamine selected from:
   a1) a linear aliphatic C₂ to C₂₄ diamine; and/or
   a2) a cycloaliphatic C₆ to C₁₈ diamine; and/or
   a3) an aromatic, preferably C₆ to C₂₄, diamine;
b) at least one saturated hydroxylated C₃-C₃₆ carboxylic acid;
c) at least one monoacid selected from saturated linear and non-hydroxylated 02 to 018 carboxylic acids.

The linear aliphatic C₂ to C₂₄ diamine a1) is preferably a C₂ to C₁₂ diamine, and preferentially a C₂ to C₈ diamine, and even more preferentially a C₂ to C₆ diamine.

According to a preferred embodiment, the linear aliphatic diamines a1) are chosen from the group consisting of ethylenediamine, propylenediamine, butylene (or tetramethylene) diamine, pentamethylenediamine, hexamethylenediamine, and even more preferably, the linear aliphatic diamine is ethylenediamine.

The cycloaliphatic C₆ to C₁₈ diamine a2) is preferably a cycloaliphatic C₆ to C₁₂ diamine.

As examples of suitable cycloaliphatic diamines a2), mention may be made of: 1,3-, 1,4- and 1,2-diamine, and in particular 1,3- and 1,4-cyclohexane, isophorone diamine, bis(aminomethyl)-1,3-, -1,4- or -1,2-cyclohexane (derived from the hydrogenation of respectively m-, p-, o-xylylenediamine), preferably bis(aminomethyl)-1,3- or -1,4-cyclohexane, decahydronaphthalenediamine, bis(3-methyl-4-aminocyclohexyl)methane (BMACM) or bis(4-aminocyclohexyl)methane (BACM), 1-{[4-(aminomethyl)cyclohexyl]oxy}propan-2-amine.

The aromatic diamine a3) is even more preferentially a C₆ to C₁₂ aromatic diamine.

Examples of aromatic diamines a3) include: m-, p-xylylenediamine, m-, p-phenylenediamine and m-, p-toluylenediamine.

The saturated hydroxylated C₃-C₃₆ carboxylic acid b) is preferably chosen from the group consisting of 12-hydroxystearic acid (12-HSA), 9- or 10-hydroxystearic acid (9-HSA or 10-HSA), 14-hydroxyeicosanoic acid (14-HEA), and mixtures thereof.

The monoacid c) is preferably chosen from saturated linear and non-hydroxylated C₆ to C₁₂ carboxylic acids.

The monoacid chosen from linear saturated and non-hydroxylated C₂ to C₁₈ carboxylic acids is preferably chosen from acetic acid, propionic acid, butyric acid, pentanoic acid, hexanoic (caproic) acid, heptanoic acid, octanoic acid, decanoic acid and mixtures thereof.

In general, the diamine a/(saturated hydroxylated carboxylic acid b+monoacid c) molar ratio can range from 0.9 to 1.1, preferably from 0.95 to 1.05, and even more preferentially is 1/1.

The monoacid c) can be present in a content such that the molar ratio of the saturated hydroxylated carboxylic acid b/(saturated hydroxylated carboxylic acid b+monoacid c) ranges from 0.01 to 0.99, preferably from 0.05 to 0.95.

According to one embodiment, said at least reaction product iii) mentioned above is in the form of a micronized powder, preferably having a volume-average size of less than 20 μm, more preferentially less than 15 μm.

The determination of said volume-average size can be carried out with a measuring device equipped with a laser detector.

The micronization can be carried out by mechanical milling optionally followed by sieving, or by air jet milling to obtain the finest powders with a controlled and narrower particle size distribution.

According to one preferred embodiment, the electrolyte composition according to the invention comprises at least one product from reaction of a mixture comprising:

a) at least one linear aliphatic C₂ to C₂₄ diamine preferably chosen from hexamethylenediamine and ethylenediamine;

b) at least one saturated hydroxylated C₃-C₃₆ carboxylic acid;

c) at least one monoacid selected from saturated linear and non-hydroxylated C₂ to C₁₈ carboxylic acids.

The at least one reaction product iii) can be obtained following the mixing of the compounds a), b) and c), and their reaction at a temperature ranging from 140° C. to 250° C., preferably from 150° C. to 200° C. The reaction is preferably carried out under an inert atmosphere.

The total weight content of reaction product(s) iii) mentioned above, in the electrolyte composition, can range from 0.5% to 20% by weight, preferably from 1% to 15% by weight, and even more preferentially from 2% to 10% by weight, relative to the total weight of the composition.

Additive(s)

The abovementioned electrolyte composition may comprise at least one electrolytic additive.

The electrolytic additive can be chosen from the group consisting of fluoroethylene carbonate (FEC), vinylene carbonate, difluoroethylene carbonate, 4-vinyl-1,3-dioxolan-2-one, pyridazine, vinyl pyridazine, quinoline, vinyl quinoline, butadiene, sebaconitrile, alkyl disulfides, fluorotoluene, 1,4-dimethoxytetrafluorotoluene, t-butylphenol, di-t-butylphenol, tris(pentafluorophenyl)borane, oximes, aliphatic epoxides, halogenated biphenyls, methacrylic acids, allylethyl carbonate, vinyl acetate, divinyl adipate, acrylonitrile, 2-vinylpyridine, maleic anhydride, methyl cinnamate, phosphonates, vinyl-containing silane compounds, 2-cyanofuran, lithium bis(oxalato)borate (LiBOB), lithium difluoro(oxalato)borate (LiDFOB), LiPO₂F₂, and mixtures thereof.

The electrolytic additive is preferably chosen from the group consisting of fluoroethylene carbonate (FEC), vinylene carbonate, lithium difluoro(oxalato)borate (LiDFOB), LiPO₂F₂, and mixtures thereof.

Even more preferably, the electrolytic additive is fluoroethylene carbonate (FEC).

The total weight content of the electrolytic additive(s) in the electrolyte composition can range from 0.01% to 10%, preferably from 0.1% to 4% by weight relative to the total weight of the composition. Preferentially, the content of additive(s) (A) in the electrolyte composition is less than or equal to 3% by weight, relative to the total weight of the composition.

The electrolyte composition can be prepared by mixing the various compounds, for example at 23° C.

Electrochemical Cell

The present application also relates to an electrochemical cell comprising a negative electrode, a positive electrode and an electrolyte composition as defined here above, in particular interposed between the negative electrode and the positive electrode. The electrochemical cell can also comprise a separator, in which the electrolyte composition as defined above is impregnated.

The present invention also relates to a battery comprising at least one electrochemical cell as described above. When the battery comprises several electrochemical cells according to the invention, said cells can be assembled in series and/or in parallel.

In the context of the invention, negative electrode is intended to mean the electrode which acts as anode when the battery produces current (that is to say, when it is in the process of discharging) and which acts as cathode when the battery is in the process of charging.

The negative electrode typically comprises an electrochemically active material, optionally an electronically conductive material, and optionally a binder.

In the context of the invention, “electrochemically active material” is intended to mean a material capable of reversibly inserting ions.

In the context of the invention, “electronically conductive material” is intended to mean a material capable of conducting electrons.

According to one preferred embodiment, the negative electrode of the electrochemical cell comprises lithium as electrochemically active material.

More particularly, the negative electrode of the electrochemical cell comprises lithium metal or a lithium-based alloy, which may be in the form of a film or a rod. Among the lithium-based alloys, mention may be made, for example, of lithium-aluminum alloys, lithium-silica alloys, lithium-tin alloys, Li—Zn, Li—Sn, Li₃Bi, Li₃Cd and Li₃SB.

An example of a negative electrode may be an active lithium film prepared by rolling a strip of lithium between rollers.

In the context of the invention, positive electrode is intended to mean the electrode which acts as cathode when the battery produces current (that is to say, when it is in the process of discharging) and which acts as anode when the battery is in the process of charging.

The positive electrode typically comprises an electrochemically active material, optionally an electronically conductive material, and optionally a binder.

The positive electrode of the electrochemical cell may comprise an electrochemically active material chosen from manganese dioxide (MnO₂), iron oxide, copper oxide, nickel oxide, lithium/manganese composite oxides (for example LiₓMn₂O₄ or LiₓMnO₂), lithium/nickel composition oxides (for example LiₓNiO₂), lithium/cobalt composition oxides (for example LiₓCoO₂), lithium/nickel/cobalt composite oxides (for example LiNi_{1-y}Co_{y}O₂), lithium/nickel/cobalt/manganese composite oxides (for example LiNiₓMn_{y}Co_{z}C₂ with x+y+z=1), lithium-enriched lithium/nickel/cobalt/manganese composite oxides (for example Li₁₊ₓ(NiMnCo)₁₋ₓO₂), lithium/transition metal composite oxides, lithium/manganese/nickel composite oxides of spinel structure (for example LiₓMn_{2-y}Ni_{y}O₄), lithium/phosphorus oxides of olivine structure (for example LiₓFePO₄, LiₓFe_{1-y}Mn_{y}PO₄ or LiₓCoPO₄), iron sulfate, vanadium oxides, and mixtures thereof.

Preferably, the positive electrode comprises an electrochemically active material chosen from LiCoO₂, LiFePO₄ (LFP), LiMnₓCo_{y}Ni_{z}O₂(NMC, with x+y+z=1), LiFePO₄F, LiFeSO₄F, LiNiCoAlO₂ and mixtures thereof.

The material of the positive electrode can also comprise, besides the electrochemically active material, an electronically conductive material, such as a carbon source, including, for example, carbon black, Ketjen® carbon, Shawinigan carbon, graphite, graphene, carbon nanotubes, carbon fibers (such as vapor-grown carbon fibers (VGCF)), non-powdery carbon obtained by carbonization of an organic precursor, or a combination of two or more of these. Other additives can also be present in the material of the positive electrode, such as lithium salts or inorganic particles of ceramic or glass type, or also other compatible active materials (for example sulfur).

The material of the positive electrode can also comprise a binder. Nonlimiting examples of binders comprise linear, branched and/or crosslinked polyether polymer binders (for example polymers based on poly(ethylene oxide) (PEO), or poly(propylene oxide) (PPO) or on a mixture of the two (or an EO/PO copolymer), and optionally comprising crosslinkable units), water-soluble binders (such as SBR (styrene/butadiene rubber), NBR (acrylonitrile/butadiene rubber), HNBR (hydrogenated NBR), CHR (epichlorohydrin rubber), ACM (acrylate rubber)), or binders of fluoropolymer type (such as PVDF (polyvinylidene fluoride), PTFE (polytetrafluoroethylene)), and combinations thereof. Some binders, such as those which are soluble in water, can also comprise an additive, such as CMC (carboxymethyl cellulose).

### Uses

The present application also relates to the use of an electrolyte composition as defined above, in a battery, in particular a Li-ion battery, said battery preferably comprising a negative electrode based on lithium, and in particular based on lithium metal.

These batteries can be used in mobile devices, for example cell phones, cameras, tablets or laptops, in electric vehicles, or in the storage of renewable energy.

The present invention also relates to the use of the electrolyte composition as described above in an electrochemical cell comprising at least one negative electrode comprising lithium, and in particular lithium metal, for reducing or eliminating the growth of lithium dendrites on the surface of said electrode.

The electrolyte composition according to the invention advantageously makes it possible to reduce the formation of lithium dendrites in an electrochemical cell comprising lithium as electrochemically active anode material. This advantageously makes it possible to improve the lifetime of the battery.

The electrolyte composition according to the invention advantageously makes it possible to reduce the risks of leakage compared with liquid electrolyte compositions (low viscosity).

In the context of the invention, the term “of between x and y” or “between x and y” means an interval in which the limits x and y are included. For example, the range “of between 85% and 100%” or “from 85% to 100%” includes in particular the values 85% and 100%.

All the embodiments described above can be combined with one another.

The following examples illustrate the invention without, however, limiting it.

### EXPERIMENTAL SECTION

### Abbreviations

EC: ethylene carbonate

EMC: ethyl methyl carbonate (CAS 623-53-0)

FEC: fluoroethylene carbonate

DOL: Dioxolane

DME: Dimethoxyethane

12-HSA: 12-hydroxystearic acid

EDA: ethylenediamine

### Suppliers

EC: BASF Corporation

EMC: BASF Corporation

FEC: BASF Corporation

LiPF₆: BASF Corporation

DOL: BASF Corporation

DME: BASF Corporation

12-HSA: Jayant

EDA: Sigma-Aldrich

Decanoic acid: Unilever

The LiFSI used is obtained in particular by the process described in the application WO2015/158979, while the LiTDI results from the process described in the application WO2013/072591.

### Amine Number Measurement Method:

The amine number was determined in accordance with standard DIN 53176 using a 50:50 v/v xylene/ethanol mixture as titration solvent. The sample is weighed into a 250 ml Erlenmeyer flask and dissolved in 100 ml of the hot xylene/ethanol mixture (approximately 90° C.) on a magnetic stirrer. The sample is subsequently placed on the magnetic stirrer of the titrimeter, the electrode is thoroughly immersed and the mixture is titrated with a 0.1 N isopropanolic HCl Solution

### Acid Number Measurement Method:

The acid number was determined in accordance with standard DIN EN ISO 2114 using a 50:50 v/v xylene/ethanol mixture as titration solvent. The sample was weighed into a 250 ml Erlenmeyer flask and dissolved in 100 ml of the hot xylene/ethanol mixture (approximately 90° C.) on a magnetic stirrer. The sample is subsequently placed on the magnetic stirrer of the titrimeter, the electrode is thoroughly immersed and the mixture is titrated with a 0.1 ethanolic KOH solution.

### Viscosity Measurement Method

The viscosity was measured in accordance with standard NF EN ISO 2555 using a Brookfield® viscometer at 23° C. (spindle: S 5). A spindle of cylindrical shape rotates at a constant rotational speed around its axis in the product to be examined. The resistance which is exerted by the fluid on the spindle depends on the viscosity of the product. This resistance brings about torsion of the spiral spring, which is reflected in a viscosity value. The speed of the spindle is fixed at 10 rpm.

### Tube Inversion Method

Visual method by tube inversion: The prepared diamide is dispersed in a tube containing the liquid electrolyte and is then heated until complete dissolution. After cooling to ambient temperature and resting for 24 h, the tube is turned over to study the gel formation. The formation of the gel is the result of the self-assembly of the amide by virtue of noncovalent interactions (H bonding, van der Waals forces, etc.) to give a 3D network of fibers. The solid appearance of the gel is the result of the immobilization of the electrolyte by the 3D network of fibers of the diamide.

### Example 1: Production of the Diamide a

29.46 g of ethylenediamine (0.98 mol, 1 eq), 113.73 g of 12-hydroxystearic acid (0.36 mol, 0.74 eq) and 106.81 g of decanoic acid (0.62 mol, 1.26 eq) are added to a 1 liter round-bottomed flask equipped with a thermometer, a Dean Stark apparatus, a condenser and a stirrer. The mixture is heated to 180° C. under an inert atmosphere. The water removed accumulates in the Dean-Stark apparatus from 150° C. The reaction is monitored by the acid number and the amine number. When the acid and amine numbers are respectively less than 5, the reaction is halted. The reaction mixture is cooled to 140° C. and is discharged into a silicone mold. Once cooled to ambient temperature, the product is converted into flakes.

### Example 2: Production of the Diamide B

29.46 g of ethylenediamine (0.98 mol, 1 eq), 154.79 g of 12-hydroxystearic acid (0.49 mol, 1 eq) and 84.41 g of decanoic acid (0.49 mol, 1 eq) are added to a 1 liter round-bottomed flask equipped with a thermometer, a Dean Stark apparatus, a condenser and a stirrer. The mixture is heated to 180° C. under an inert atmosphere. The water removed accumulates in the Dean-Stark apparatus from 150° C. The reaction is monitored by the acid number and the amine number. When the acid and amine numbers are respectively less than 5, the reaction is halted. The reaction mixture is cooled to 140° C. and is discharged into a silicone mold. Once cooled to ambient temperature, the product is converted into flakes.

### Example 3: Production of Gel Electrolyte

The product of example 1 (or of example 2) was dissolved in a liquid composition with stirring (1 M LiFSI and a mixture of DOL/DME solvents in a 50/50 weight ratio) at a given concentration while heating and then cooling gently to ambient temperature to allow a gel to be obtained. Gelation was confirmed by the test tube inversion method.

TABLE 1

| | | % by weight | | | |
|---|---|---|---|---|---|
| | | relative to the | | | |
| | | total weight of | | | |
| | | solvent | | Viscosity | |
| | Dissolved | DOL/DME + | Appearance of the final | measured at | |
| | product | LiFSI | electrolyte | 23° C. (10 rpm) | |
| Electrolyte A | Product of | 5 | Gel | 52 000 | mPa · s |
| | example 1 | | | | |
| Electrolyte B | Product of | 7.5 | Gel | 63 000 | mPa · s |
| | example 1 | | | | |
| Electrolyte C | Product of | 5 | Gel | 120 | mPa · s |
| | example 2 | | | | |
| Electrolyte D | Product of | 7.5 | Gel | 2100 | mPa · s |
| | example 2 | | | | |

### Example 4: Dendrite Test

A dendrite test was carried out with the electrolyte A prepared in example 3, and with a reference electrolyte corresponding to LiFSI at 1 mol/l in a 50/50 by weight DOL/DME solvent mixture (Ref 1).

Method: The method consists in charging and discharging a symmetrical Li metal/Li metal battery; the potential of the battery is then measured. This potential is proportional to the surface area of the electrodes, therefore the appearance of dendrites results in an increase in potential.

### System Used:

Cathode: Lithium metal
Anode: Lithium metal
The battery is charged using a positive current of 0.25 mA to an energy density of 0.25 mAh.
The battery is then discharged using a negative current of 0.25 mA to an energy density of 0.25 mAh.

### Results:

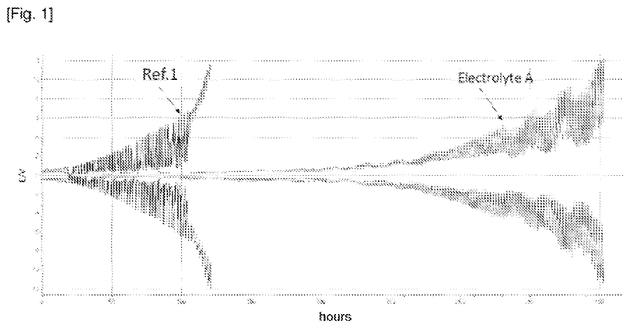

FIG. 1 shows the potential (in e/V) as a function of time (in hours) for the electrolyte A and reference electrolyte Ref 1.

FIG. 1 shows the formation of dendrites is delayed with the electrolyte A (invention) compared to the reference composition (Ref 1). The electrolyte C can advantageously be used in a battery comprising a lithium metal anode without risk to safety, and with a better battery life.

### Example 5: Ionic Conductivity

### Method:

A conductivity cell is then immersed in each of the solutions and three impedance spectroscopy determinations were carried out. These spectroscopy determinations are carried out between 500 mHz and 100 kHz with an amplitude of 10 mV. The constant of the cell used is 1.12 and the ionic conductivity is calculated according to the following formula:

$$σ = \frac{1}{R} \times 1.12$$

where R represents the resistance which is obtained by linear regression of the curve Im(Z)=f(Re(Z)). In the specific case of Im(Z)=0, R is equal to the opposite of the ordinate at the origin divided by the slope of the linear regression equation.

### System Used:

TABLE 2

| | | | Ionic conductivity |
|---|---|---|---|
| Additive | Amount | Electrolyte | (mS/cm) |
| Diamide A | 5% by weight | Electrolyte A of | 0.11 |
| (example 1) | | example 3: | |
| | | 1M LiFSI | |
| | | 50/50 DOL/DME | |
| Diamide A | 5% by weight | Electrolyte E: | 0.15 |
| (Example 1) | | 1M LiFSI | |
| | | DME | |
| Diamide B | 5% by weight | Electrolyte: | 0.26 |
| (example 2) | | 1M LiFSI | |
| | | 50/50 DOL/DME | |
| POE | O/Li = 16 | LiPF₆ | 10⁻⁵ |

Ref B. K. Choi, Y. W. Kim, Electrochim Acta. (2004) 2307-2313

1. An electrolyte composition comprising:
i) at least one lithium salt;
ii) at least one nonaqueous solvent; and
iii) at least one product from reaction of a mixture comprising:
a) at least one diamine selected from:
a1) a linear aliphatic C₂ to C₂₄ diamine; and/or
a2) a cycloaliphatic C₆ to C₁₈ diamine; and/or
a3) an aromatic, preferably C₆ to C₂₄, diamine;
b) at least one saturated hydroxylated C₃-C₃₆ carboxylic acid;
c) at least one monoacid selected from saturated linear and non-hydroxylated C₂ to C₁₈ carboxylic acids;
said composition being characterized in that it has a viscosity measured at 23° C. ranging from 10¹ to 10⁷ mPa·s.

2. The electrolyte composition as claimed in claim 1, wherein the lithium salt is chosen from the group consisting of LiPF₆ (lithium hexafluorophosphate), LiFSI, LiTDI, LiTFSI (lithium bis(trifluorosulfonyl)imide), LiPOF₂, LiB(C₂O₄)₂, LiF₂B(C₂O₄)₂, LiBF₄, LiNO₃, LiCIO₄, and mixtures thereof.

3. The electrolyte composition as claimed in claim 1, wherein the lithium salt is LiFSI.

4. The electrolyte composition as claimed in claim 1, wherein the total molar concentration of lithium salt(s) in the electrolyte composition ranges from 0.01 mol/l to 5 mol/l.

5. The electrolyte composition as claimed in claim 1, wherein the nonaqueous solvent is chosen from the group consisting of ethers, esters, carbonates, ketones, partially hydrogenated hydrocarbons, nitriles, amides, sulfoxides, sulfolane, nitromethane, 1,3-dimethyl-2-imidazolidinone, 1,3-dimethyl-3,4,5,6-tetrahydro-2(1H)-pyrimidinone, 3-methyl-2-oxazolidinone and mixtures thereof.

6. The electrolyte composition as claimed in claim 1, wherein the nonaqueous solvent is chosen from the group consisting of carbonates, ethers and mixtures thereof.

7. The electrolyte composition as claimed in claim 1, wherein the total weight content of nonaqueous solvent(s) in the electrolyte composition is greater than or equal to 40% by weight, relative to the total weight of the composition.

8. The electrolyte composition as claimed in claim 1, wherein the linear aliphatic diamines a1) are chosen from the group consisting of ethylenediamine, propylenediamine, butylene (or tetramethylene) diamine, pentamethylenediamine, hexamethylenediamine.

9. The electrolyte composition as claimed in claim 1, wherein the saturated hydroxylated C₃-C₃₆ carboxylic acid b) is chosen from the group consisting of 12-hydroxystearic acid (12-HSA), 9- or 10-hydroxystearic acid (9-HSA or 10-HSA), 14-hydroxyeicosanoic acid (14-HEA), and mixtures thereof.

10. The electrolyte composition as claimed in claim 1, wherein the monoacid c) is chosen from acetic acid, propionic acid, butyric acid, pentanoic acid, hexanoic (caproic) acid, heptanoic acid, octanoic acid, decanoic acid and mixtures thereof.

11. The electrolyte composition as claimed in claim 1, wherein the diamine a)/(saturated hydroxylated carboxylic acid b+monoacid c) molar ratio ranges from 0.9 to 1.1.

12. The electrolyte composition as claimed in claim 1, wherein the composition comprises at least one product from reaction of a mixture comprising:
a) at least one linear aliphatic C₂ to C₂₄ diamine;
b) at least one saturated hydroxylated C₃-C₃₆ carboxylic acid;
c) at least one monoacid selected from saturated linear and non-hydroxylated C₂ to C₁₈ carboxylic acids.

13. The electrolyte composition as claimed in claim 1, wherein the total weight content of reaction product(s) (iii) in the electrolyte composition ranges from 0.5% to 20% by weight, relative to the total weight of the composition.

14. The electrolyte composition as claimed in claim 1, wherein the molar ratio of the saturated hydroxylated carboxylic acid b/(saturated hydroxylated carboxylic acid b+monoacid c) ranges from 0.01 to 0.99.

15. The electrolyte composition as claimed in claim 1, wherein the composition comprises at least one electrolytic additive.

16. An electrochemical cell comprising a negative electrode, a positive electrode and an electrolyte composition as defined here in claim 1, interposed between the negative electrode and the positive electrode.

17. The cell as claimed in claim 16, wherein the negative electrode comprises lithium as electrochemically active material.

18. A battery comprising the electrochemical cell as claimed in claim 16.

19. A method for reducing or eliminating the growth of lithium dendrites on a surface of an electrode, the method comprising using the electrolyte composition as claimed in claim 1 in an electrochemical cell comprising at least one negative electrode comprising lithium.
